(19) United States
(12) Patent Application Publication
(10) Pub. No.: US 2011/0157187 A1
(43) Pub. Date: Jun. 30, 2011

(54) CHARACTER STRING DISPLAY DEVICE, CHARACTER STRING DISPLAY METHOD AND STORAGE MEDIUM

(75) Inventors: Kazuo Ura, Fussa-shi (JP); Masao Sambongi, Hachioji-shi (JP)

(73) Assignee: CASIO COMPUTER CO., LTD., Tokyo (JP)

(21) Appl. No.: 12/950,217

(22) Filed: Nov. 19, 2010

(30) Foreign Application Priority Data
Dec. 25, 2009 (JP) 2009-294365

(51) Int. Cl. G06T 11/00

(52) U.S. Cl. 345/467

(57) ABSTRACT

In a map display device 1, a character string is drawn in a rightward direction from a drawing start point based on ordinary character string data in which the drawing start point is set on the left side of the character string, and a character string is drawn in a leftward direction from a drawing start point based on inverted character string data in which the drawing start point is set on the right side of the character string. As a result, a character string whose right side should be on a predetermined position is set as ordinary character string data and drawn by ordinary character string drawing, and a character string whose left side should be on a predetermined position is set as inverted character string data and drawn by inverted character string drawing.

### CROSS-REFERENCE TO RELATED APPLICATION

This application is based upon and claims the benefit of priority from the prior Japanese Patent Application No. 2009-294365, filed Dec. 23, 2009, the entire contents of which is incorporated herein by reference.

### BACKGROUND OF THE INVENTION

1. Field of the Invention

The present invention relates to a character string display device that displays a character string on a display screen, a character string display method and a storage medium.

2. Description of the Related Art

For example, when a map is outputted and displayed, a character string is also outputted and displayed to display a location name, etc. The display of the character string is performed such that each character is drawn in sequence from a designated drawing start point using font data corresponding to the designated character string.

When a character string is to be displayed near each of a plurality of indication points set on an image to indicate their respective names and the like, the layout of the character strings is designed such that the indication points and the corresponding character strings are positioned close to each other with an appropriate distance therebetween, and the character strings do not overlap with each other, and then a display database including its image data and character string data is created.

U.S. Pat. No. 5,297,051 discloses a conventional technology related to the present invention, in which even when a display direction is changed to any of the north, east, west, and south directions during the display of map information, the character strings are displayed with their direction corrected to an appropriate direction.

In the output and the display of an image and a character string in accordance with a display database including image data and character string data, font data of the character string, and the size ratio of the image and the font may differ from those used when designing the layout of the character string.

This may cause the following problems. In the case of a character string whose display frame is set to the left side of an indication point, if a font having a wide character width in relation to the image size is used as a result of the above, the character string runs off the right side of the display frame causing the character string and the indication point to overlap. Conversely, if a font having a narrow character width in relation to the image size is used, the character string is placed on the left side of the display frame which is distant from the indication point.

Such problems occur when, for example, character strings are designed to be placed to the left of the respective indication points so that a plurality of character strings do not overlap in an area where indication points are concentrated.

Therefore, conventionally, when a character string whose font data and size ratio of image and font have been modified is to be displayed on an image, the character string is required to be drawn after complicated processing is performed to correct the display position of the character string accordingly based on the font data, so that the character string and the indication point do not overlap and the character string is not placed distant from the indication point.

An object of the present invention is to enable a character string, which is shown on the side of a discretionary point on era image, to be displayed without disrupting a layout relationship with the corresponding point, without complicated processing.

### SUMMARY OF THE INVENTION

In accordance with one aspect of the present invention, there is provided a character string display device that displays a character string on a display screen, comprising: an ordinary character string drawing means for drawing a character string in a rightward direction from a drawing start point based on ordinary character string data in which the drawing start point is set on a left side of the character string; and an inverted character string drawing means for drawing a character string in a leftward direction from a drawing start point based on inverted character sting data in which the drawing start point is set on a right side of the character string.

In accordance with another aspect of the present invention, there is provided a character string display method for displaying a character string on a display screen, comprising an ordinary character string drawing step of drawing each character of a character string in sequence from a starting character to an ending character in a rightward direction from a drawing start point, based on ordinary character string data in which the drawing start point is set on a left side of the character string; an inverted character string drawing step of drawing each character of a character string in sequence from an ending character to a starting character in a leftward direction from a drawing start point, based on inverted character string data in which the drawing start direction is set on a right side of the character string; and a display outputting step of outputting to the display screen an image based on drawing performed in the ordinary character string drawing step and in the inverted ordinary character string drawing step.

In accordance with another aspect of the present invention, there is provided a non-transitory computer-readable recording medium having a program stored thereon which is executable by a computer that generates display data of an output image, the program comprising program code for actualizing an ordinary character string drawing function that draws each character of a character string in sequence from a starting character to an ending character in a rightward direction from a drawing start point, based on ordinary character string data in which the drawing start point is set on a left side of the character string; and program code for actualizing an inverted character string drawing function that draws each character of a character string in sequence from an ending character to a starting character in a leftward direction from a drawing start point, based on inverted character string data in which the drawing start point is set on a right side of the character string.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram showing the overall configuration of a map display device according to an embodiment of the present invention;

FIG. 2 is a functional block diagram showing the functional configuration of the map display device according to the embodiment;

FIG. 3 is a data chart showing an example of a map database;

FIG. 4A, FIG. 4B and FIG. 4C are explanatory diagrams showing a layout relationship between a character string that is registered in an uninverted character string layer and a location symbol;

FIG. 5A, FIG. 5B and FIG. 5C are explanatory diagrams showing a layout relationship between a character string that is registered in an inverted character string layer and a location symbol;

FIG. 6A and FIG. 6B are diagrams showing data in each layer of the map database as images, of which FIG. 6B is an image created when ordinary drawing of the data in each layer is performed, and FIG. 6B is an image that is actually outputted to a display device;

FIG. 7 is a flowchart of a control procedure in map drawing processing performed by a CPU;

FIG. 8 is a flowchart of a control procedure in inverted character string layer inverted drawing processing performed at Step S8 in FIG. 7;

FIG. 9A, FIG. 9B and FIG. 9C are explanatory diagrams showing the details of the inverted character string layer inverted drawing processing, of which FIG. 9A is a diagram showing a single piece of inverted character string data, FIG. 9B is a diagram showing a first stage after the drawing of the inverted character string data is started, and FIG. 9C is a diagram showing a second stage after the drawing of the inverted character string data is started;

FIG. 10 is a flowchart showing a control procedure in uninverted character string layer ordinary drawing processing performed at Step S7 in FIG. 7;

FIG. 11 is a flowchart. showing a control procedure in inverted character string layer ordinary drawing processing performed at Step S10 in FIG. 7; and

FIG. 12 is a flowchart showing a control procedure in uninverted character string layer inverted drawing processing performed at Step 9 in FIG. 7.

### DETAILED DESCRIPTION OF THE PREFERRED EMBODIMENTS

The present invention will hereinafter be described in detail with reference to the preferred embodiment shown in the accompanying drawings.

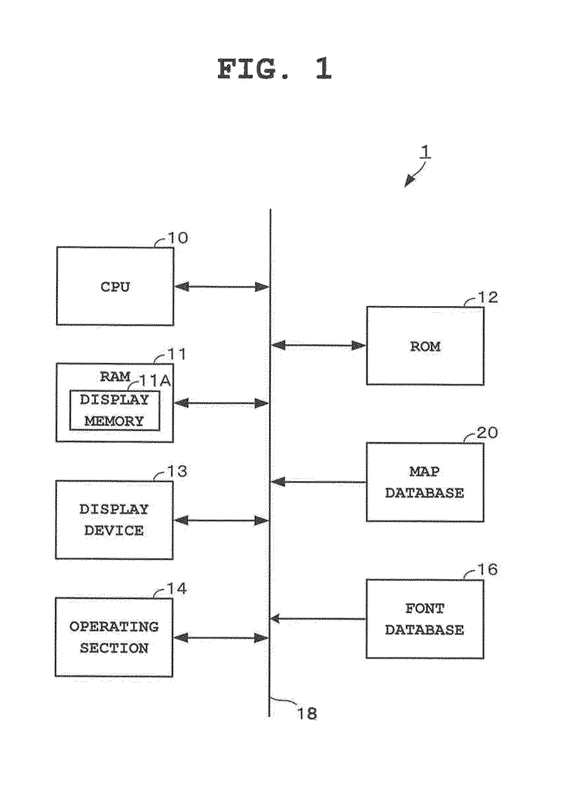

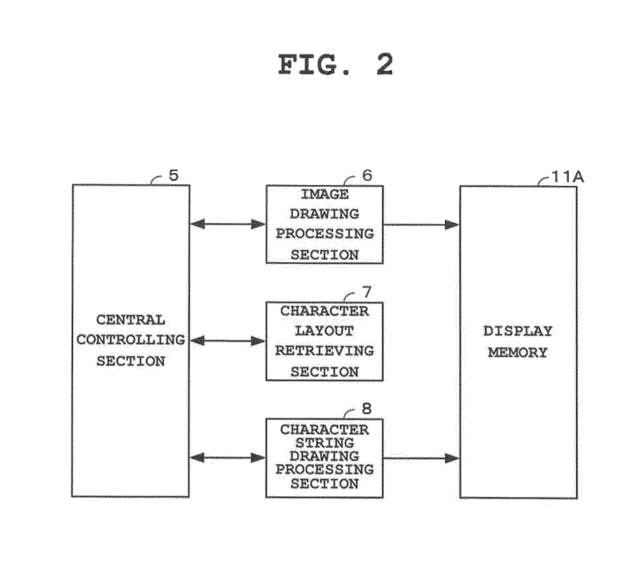

FIG. 1 is a block diagram showing the overall configuration of a map display device according to an embodiment of a character string display device of the present invention. FIG. 2 is a functional block diagram showing the functional configuration of the map display device according to the embodiment.

A map display device 1 according to the embodiment is a device that outputs and displays a map image on which character strings are superimposed. As shown in FIG. 1, the map display device 1 includes a central processing unit (CPU) 10 (corresponding to a computer) that runs programs, a read-only memory (ROM) 12 that stores control programs run by the CPU 10 and control data, a random access memory (RAM) 11 that provides the CPU 10 with working memory space and has a display memory 11A, a display device 13 including a liquid crystal display that displays images, an operating section 14 that is used to externally input user's instructions, a map database 20 in which image data of a map and character string data are registered, a font database 16 in which font data is registered, and a bus 18 that is used to transfer data and commands between sections.

The display memory 11A is a memory in which data of each pixel in an image displayed in the display device 13 is developed. The display device 13 reads pixel data written in this display memory HA and performs display output of an image based on the pixel data.

The ROM 12 stores therein programs for a plurality of functional modules actualizing various functions by being run by the CPU 10. As shown in FIG. 2, the functional modules include a central controlling section 5, an image drawing processing section 6, a character layout retrieving section 7, a character string drawing processing section 8, etc. The central controlling section 5 performs the overall control of map display, such as moving the display range of a map or turning the direction of a map upside down by receiving instructions externally inputted via the operating section 14. The image drawing processing section 6 reads out image data from the map database 20 and performs drawing processing (writes the image data in the display memory 11A). The character layout retrieving section 7 reads out position data of a display frame indicated by absolute coordinates on a map image from character string data in the map database 20, and searches a drawing position in the display memory 11A. The character string drawing processing section 8 performs character string drawing processing using font data in the font database 16.

In addition to being stored in the ROM 12, the programs actualizing each functional module can be stored, for example, in a portable storage medium such as an optical disk or a non-volatile memory such as a flash memory that can be read by the CPU 10 via a data reading device. Also, a technique is applicable in which programs such as these are downloaded onto the map display device 1 via a communication line, with a carrier wave serving as a medium.

The CPU 10, the ROM 12, and the RAM 11 as a whole actualize functions of an ordinary character string drawing means, an inverted character string drawing means, a top-bottom switching means, a first drawing means, and a second drawing means.

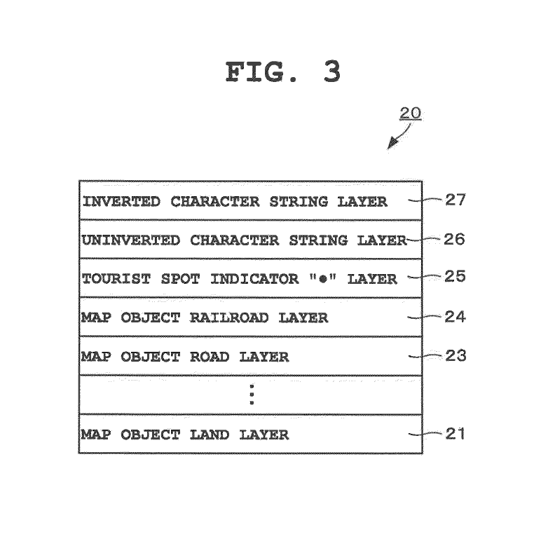

FIG. 3 is a data chart showing an example of the map database.

The map database 20 is constituted by map object layers 21 to 24 in which a plurality of map objects indicating each component of a map image are respectively registered as map image data, a tourist spot indicator layer 25 in which data of a location symbol “” that is displayed on a map is registered as location data, an uninverted character string layer 26 in which uninverted character string data (ordinary character string data) is registered, and an inverted character string layer 27 in which inverted character string data is registered, and the like.

Map objects that are registered in the map object layers 21 to 24 include each object such as land, roads and railroads serving as a component of a map image, and various formats such as raster data and vector data may be used as the data format of these map objects. The layout of each image of each map object is indicated using absolute coordinates set on a map.

Map symbol data that is registered in the tourist spot indicator layer 25 includes a map symbol type and layout data using the above-described absolute coordinates.

Uninverted character string data that is registered in the uninverted character string layer 26 is character string data in which the left end position of a character string display frame is set as a drawing start point. This uninverted character string data includes at least a code string indicating each character of a character string from its starting character to its ending character, and position data in which the left end position of a character string display frame is indicated by absolute coordinates set on a map. In the embodiment, coordinate data of the upper left corner and coordinate data of the lower right corner of a character string display frame at the time of layout design are included, and of these coordinate data, the coordinate data of the upper left corner is defined as a drawing start point.

Inverted character string data that is registered in the inverted character string layer 27 is character string data in which the right end position of a character string display frame is set as a drawing start point. This inverted character string data includes at least a code string indicating each character of a character string from its starting character to its ending character, and position data in which the right end position of a character string display frame is indicated by absolute coordinates set on a map. In the embodiment, coordinate data of the upper left corner and coordinate data of the lower right corner of a character string display frame at the time of layout design are included, and of these coordinate data, the coordinate data of the lower right corner is defined as a drawing start point.

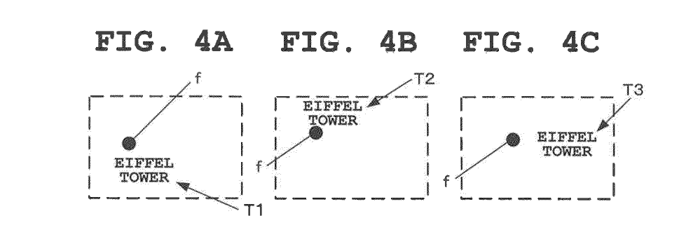

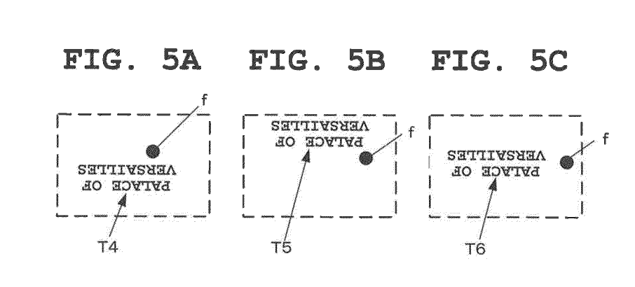

FIG. 4A, FIG. 4B and FIG. 4C are explanatory diagrams showing a layout relationship between a character string that is registered in the uninverted character string layer 26 and a location symbol, and FIG. 5A, FIG. 5B and FIG. 5C are explanatory diagram showing a layout relationship between a character string that is registered in the inverted character string layer 27 and a location symbol.

As shown in FIG. 4A, FIG. 4B and FIG. 4C, character strings T1 to T3 whose layout has been designed in such a way that a location symbol f is placed near the left area thereof are registered in the uninverted character string layer 26.

As shown in FIG. 5A, FIG. 5B and FIG. 5C, character strings T4 to T6 whose layout has been designed in such a way that a location symbol f is placed near the right area thereof are registered in the inverted character string layer 27. In FIG. 5A, FIG. 5B and FIG. 5C, the character string of the inverted character string data is shown upside down to indicate it is of inverted character string data. However, this character string is displayed in the ordinary direction when it is actually outputted to a display screen.

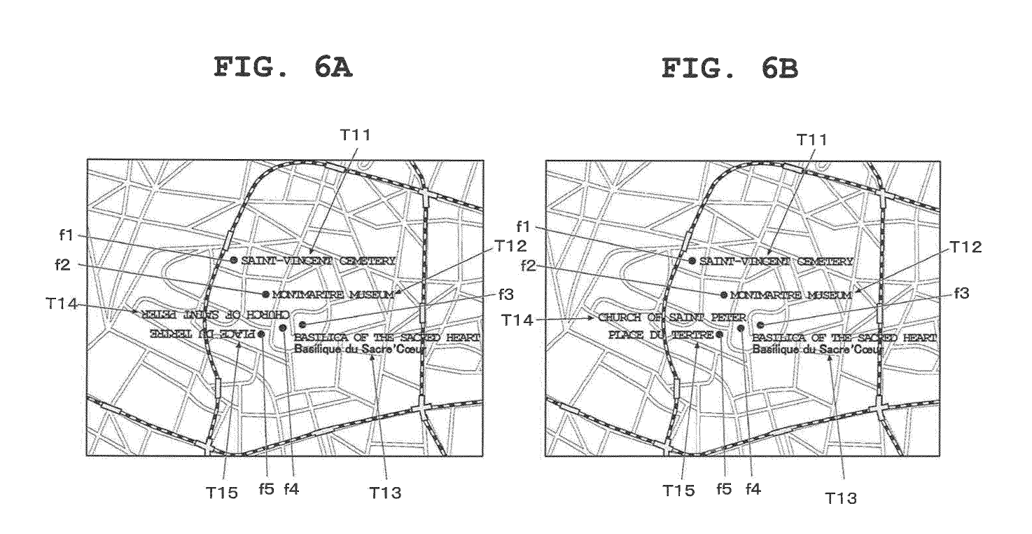

FIG. 6A and FIG. 6B are diagrams showing data in each layer of the map database as images FIG. 6A is an image created when ordinary drawing of the data in each layer is performed, and FIG. 6B is an image that is actually outputted to the display device. In FIG. 6A and FIG. 6B, reference numbers f1 to f5 indicate location symbols, and reference numbers T11 to T15 indicate character strings corresponding to the location symbols f1 to f5. Of these reference numbers, T11 to T13 are character strings belonging to the uninverted character string layer 26, and T14 and T15 are character strings belonging to the inverted character string layer 27.

As shown in FIG. 6A, the location symbols f1 to f5 and the character strings T11 to T15 are displayed superimposed on predetermined positions on an object image such as land, roads, and railroads. Here, if character strings are not concentrated as shown in the area of the location symbols f1 and f2, the character string data can be set such that the character strings are placed to the right of their location symbols. However, in a case where character strings are concentrated as shown in the area of the location symbols f3 to f 5, the character strings may overlap with each other or the character strings and their location symbols may overlap if all of the character strings are placed to the right of their location symbols. Therefore, in such instances, the character string data is set such that the character strings are placed to the lower right, the upper left, or the left of their location symbols, respectively, as indicated by the character strings T13 to T15.

In this instance, the map data base 20 is configured such that the character strings T11 to T13 placed to the right of the location symbols f1 to f3 are registered in the uninverted character string layer 26 as uninverted character string data and the character strings P14 and T15 placed to the left of the location symbols f4 and f5 are registered in the inverted character string layer 27 as inverted character string data.

In an actual image display processing, the character strings T14 and T15 of the inverted character string layer 27 are drawn to be in the ordinary direction. Therefore, normal display content such as that shown in FIG. 6B is achieved.

Next, operations of the map display device 1 configured as described above will be described.

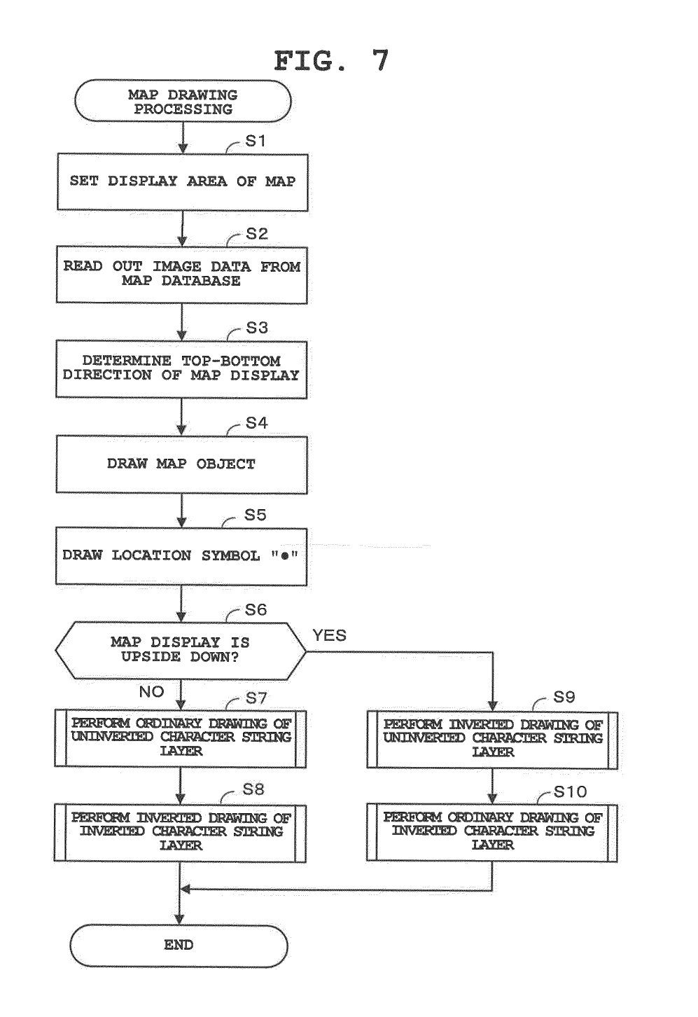

FIG. 7 shows a flowchart of map drawing processing performed by the CPU 10.

The map drawing processing is initiated when an instruction to perform map display or an instruction to update the display range of a map is entered by a user from the operating section 14. When the map drawing processing is initiated, the CPU 10 first sets a display area of the map using absolute coordinates set on the map (Step S1). Next, the CPU 10 reads out each data included in the display area from the map object layers 21 to 24 and the tourist spot indicator layer 25 in the map database 20 (Step S2).

The CPU 10 then reads in data indicating the display direction of the map set by another control processing, and determines the top-bottom direction of the map display (Step S3).

Then, functioning as the image drawing processing section 6, the CPU 10 generates corresponding image data based on the map objects read out at Step S2 and performs drawing processing for writing out the image data in a designated position in the display memory 11A (Step S4). In addition, the CPU 10 generates image data of a corresponding indication mark based on the data of the location symbol read out at Step S2 and performs drawing processing for writing out the image data in a designated position in the display memory 11A (Step S5).

As a result of the drawing processing performed at Step S4 and Step S5, the image data of land, roads, railroads, and the like of the map, and the image data of the location symbol are developed in the display memory 11A.

Next, the CPU 10 performs branch processing based on the top-bottom direction determined at Step S3 (Step S6). When the map display is in an ordinary direction, the CPU 10 sequentially performs uninverted character string layer ordinary drawing processing (Step S7) and inverted character string layer inverted drawing processing (Step S8), and terminates the map drawing processing.

Conversely, when the direction of the map display is upside down, the CPU 10 sequentially performs uninverted character string layer inverted drawing processing (Step S9) and inverted character string layer ordinary drawing processing (Step S10), and terminates the map drawing process.

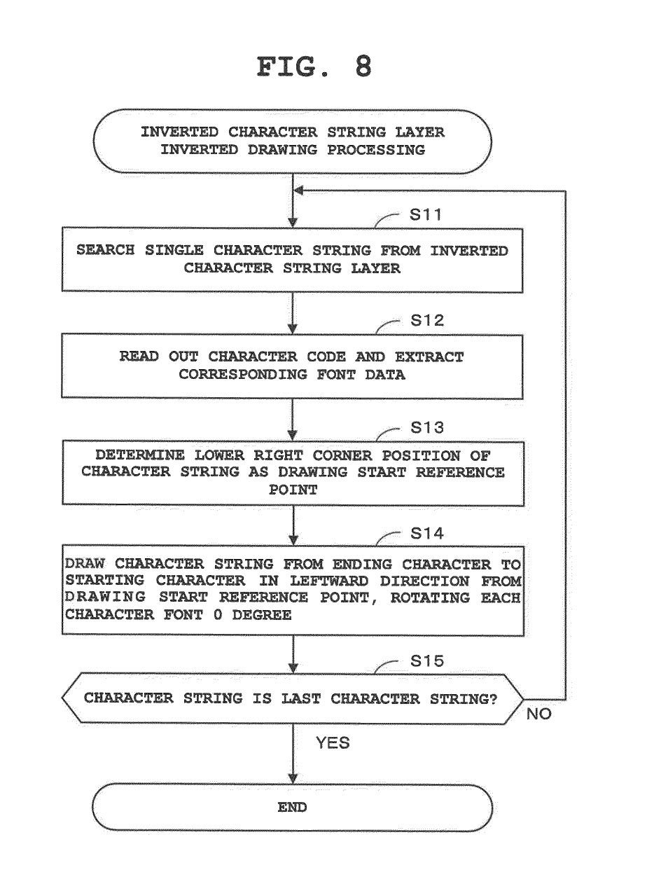

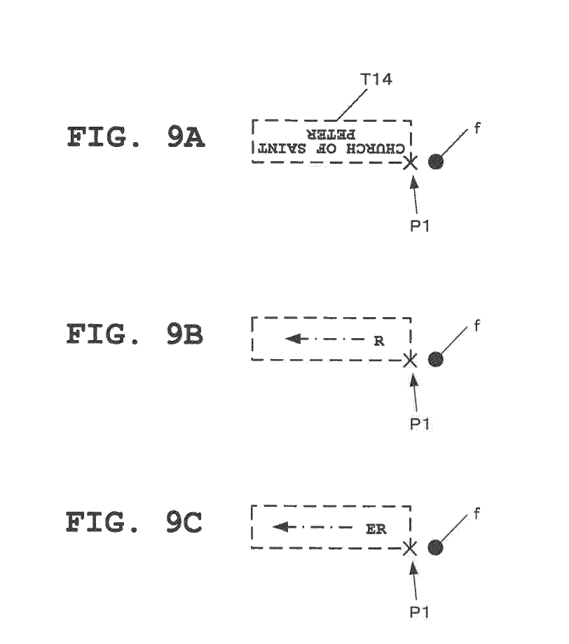

FIG. 8 is a flowchart of the inverted character string layer inverted drawing processing performed at Step S8, and FIG. 9A is an explanatory diagram showing the details of the inverted character string layer inverted drawing processing.

When the procedure proceeds to the inverted character string layer inverted drawing processing, the CPU 10 first searches character strings included in the display area from the inverted character string layer 27 of the map database 20, and extracts a single piece of inverted character string data (Step S11). Next, the CPU 10 extracts from the font database 16 font data corresponding to each character from the starting character to the ending character of the character string, using a character code written in the inverted character string data (Step S12).

Then, functioning as the character layout retrieving section 7, the CPU 10 identifies, from the coordinate data of the display frame included in the inverted character string data, the lower right corner position as a drawing start reference point P1 (FIG. 9A), and determines which point on display coordinates set in the display memory 11A this position corresponds to, by coordinate conversion (Step S13).

Next, when the drawing start reference point P1 is determined, functioning as the character string drawing processing section 8, the CPU 10 draws the character string in the display memory 11A (Step S14 inverted character string display means). That is, as shown in FIG. 9B, the CPU 10 first draws the ending character of the character string (“R” in FIG. 9B) using the font data, with the lower right corner position as the drawing start reference point P1. Then, as shown in FIG. 9C, the CPU 10 shifts the drawing start point to the left by the character width of the above-described character, and draws the next character (“E” in the example in FIG. 9C) using the font data. Thereafter, the CPU 10 repeats this processing to the starting character of the character string, whereby the character string set in the inverted character string data is drawn.

When the drawing of the single piece of inverted character string data is completed, the CPU 10 judges whether or not this inverted character string data is the last piece of inverted character string data indicating character strings included in the display area (Step S15). When judged that the character string data is not the last piece, the CPU 10 returns to Step S11 to draw the next character string. As a result of the processing at Step S11 to Step S15 being repeated in this way, the drawing processing is performed on all pieces of inverted character string data included in the display area, and the character strings are drawn in the display memory 11A.

When judged in the determination processing at Step S15 that the character string is the last, the CPU 10 terminates the inverted character string layer inverted drawing processing.

In the inverted character string layer inverted drawing processing, even when the character width of a font is changed, or the size ratio between a map image and a font is changed by the enlargement or reduction of the map image, the right end of the character string is fixed on the map image and the left end of the character string changes its position on the map image. Accordingly, an appropriate layout relationship is constantly maintained between the character string and the location point f when the location symbol f is set to the right of the character string.

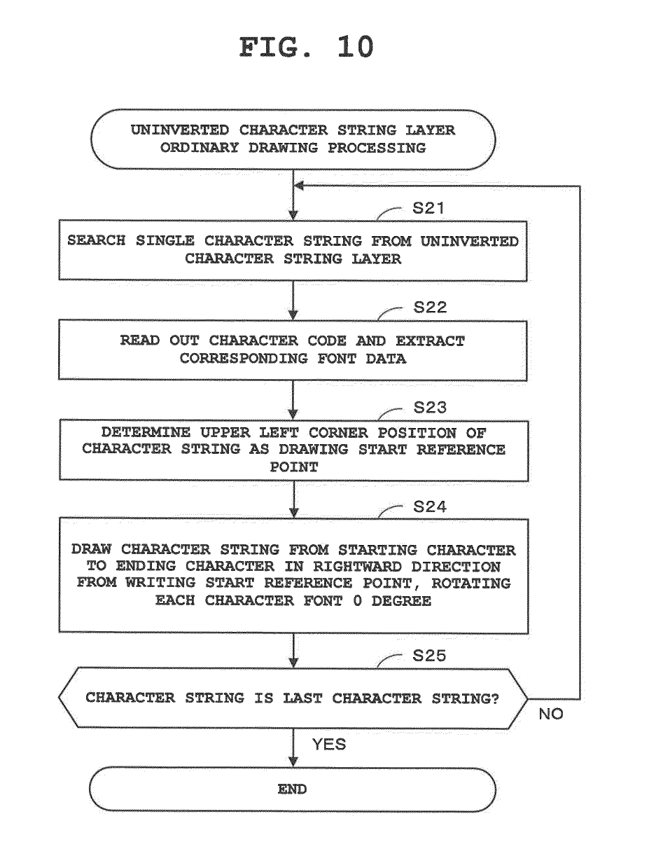

FIG. 10 is a flowchart showing the uninverted character string layer ordinary drawing processing performed at Step S7 in FIG. 7.

The uninverted character string layer ordinary drawing processing is processing that is similar to the inverted character string layer inverted drawing processing in FIG. 8 but differs therefrom in that character string data is retrieved from the uninverted character string layer 26 of the map database 20 (Step S21), the upper left corner of a character string display frame is determined as a drawing start reference point (Step S23), and a character string is drawn from its starting character to its ending character in a rightward direction from a drawing start reference point (Step S24 ordinary character string drawing means).

In the uninverted character string layer ordinary drawing processing, the left end of a character string is fixed on a map image, and when the character width of its font or the size ratio between the map image and the font is changed, the right end of the character string changes its position on the map image. Accordingly, an appropriate layout relationship is constantly maintained between the character string and the location point f when the location symbol f is set to the left of the character string.

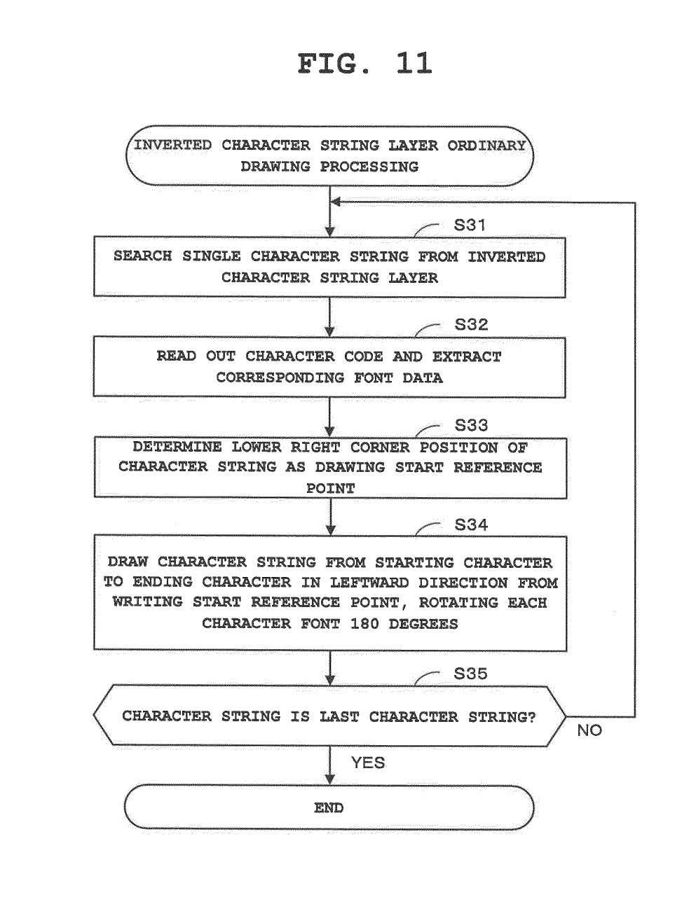

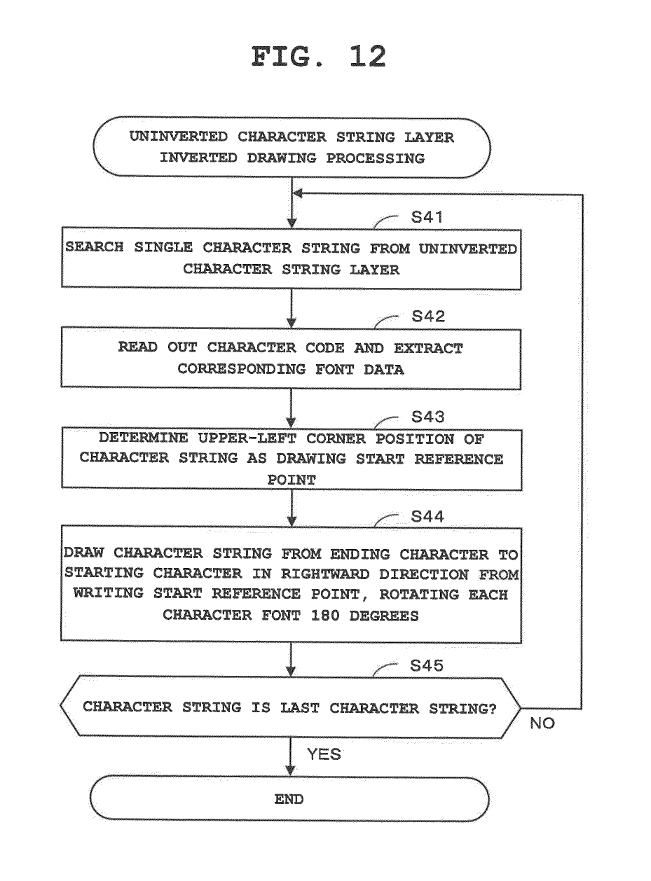

FIG. 11 is a flowchart showing the inverted character layer ordinary drawing processing performed at Step S10 in FIG. 7. FIG. 12 is a flowchart showing the uninverted character string layer inverted drawing processing performed at Step S9 in FIG. 7.

The inverted character string layer ordinary drawing processing (FIG. 11) and the uninverted character string layer inverted drawing processing (FIG. 12) are drawing processing for turning a character string upside down when the direction of map display is upside down.

When the procedure proceeds to the inverted character string layer ordinary drawing processing, the CPU 10 first performs at Step S31 to Step S33 the same processing as those at Step S11 to Step S13 in FIG. 8. Next, at a character string drawing step (Step S34), the CPU 10 performs the drawing processing in which a character string is drawn from its starting character to its ending character in a leftward direction from a drawing start reference point, with the font of each character being rotated 180 degrees. Then, after judging whether or not the last character string has been drawn at Step S35, when judged that the last character string has not been drawn, the CPU 10 repeats the processing at Step S31 to Step S35 to the last character string.

When the procedure proceeds to the uninverted character string layer inverted drawing processing, the CPU 10 first performs at Step S41 to Step S43 the same processing as those at Step S21 to Step S23 in FIG. 10. Next, at a character string drawing step (Step S44), the CPU 10 performs the drawing processing in which a character string is drawn from its ending character to its starting character in a rightward direction from a drawing start reference point, with the font of each character being rotated 180 degrees. Then, after judging whether or not the last character string has been drawn at Step S45, when judged that the last character string has not been drawn, the CPU 10 repeats the processing at Step S41 to Step S45 to the last character string.

As a result of the inverted character string layer ordinary drawing processing and the uninverted character string layer inverted drawing processing, the character string is outputted and displayed upside down while maintaining its appropriate range relationship with the location point f.

As described above, in the map display device 1 according to the embodiment, a character string of uninverted character string data whose drawing start point has been set on the left side thereof is drawn in the rightward direction from the drawing start point, as a result of the uninverted character string layer ordinary drawing processing (FIG. 10) and the uninverted character string layer inverted drawing processing (FIG. 12) being performed. In addition, a character string of inverted character string data whose drawing start point has been set on the right side thereof is drawn in the leftward direction from the drawing start point, as a result of the inverted character string layer ordinary drawing processing (FIG. 8) and the inverted character string layer inverted drawing processing (FIG. 11) being performed. Accordingly, in the map display device 1, each character string can be outputted and displayed without disrupting their appropriate layout relationship on the map image, by character strings whose left side position should not be shifted being used as uninverted character string data, and character strings whose right side position should not be shifted being used as inverted character string data.

Moreover, in the inverted character string inverted drawing processing (FIG. 8), a character string is drawn from its ending character to its starting character in a leftward direction from a drawing start point. Therefore, a character string of inverted character string data can be displayed with each character in the ordinary direction, without shifting its right side position.

Furthermore, when the top-bottom direction of a display screen of the map display device 1 is determined to be upside down, the uninverted character layer inverted drawing processing (FIG. 12) is performed in which a character string is drawn from its ending character to its starting character in a rightward direction from a drawing start point with the font turned upside down. In addition, the inverted character string layer ordinary drawing processing (FIG. 11) is performed in which a character string is drawn from its starting character to its ending character in a leftward direction from a drawing start point with the font turned upside down. Therefore, in the map display device 1 according to the embodiment, character strings can be displayed upside down without disrupting their layout relationship.

Still further, the map display device 1 according to the embodiment which includes the map database 20 having the map object layers 21 to 24, the tourist spot indicator layer 25, the uninverted character string layer 26, and the inverted character string layer 27, draws map images and character strings based on data in the map database 20. Therefore, map images and character strings can be displayed without disrupting their appropriate layout, through a simple drawing processing, by the map database 20 in which the layout of each character string has been appropriately designed being provided.

Yet still further, the map display device 1 according to the embodiment includes the font database 16, and character strings are drawn using font data therein. Therefore, although the width of a character string differs from that of when the map database 20 is designed depending on the font data, each character string can be outputted and displayed without disrupting the layout relationship between each location point and each character string on the map, by the above-described drawing processing.

Yet still further, in the map display device 1 according to the embodiment, uninverted character string data and inverted character string data include a code string indicating a character string and position data for a character string display frame indicated by absolute coordinates on a map. Accordingly, in the case of uninverted character string data, its drawing start point can be easily determined by the upper left corner of the display frame being determined as the drawing start point, and in the case of inverted character string data, its drawing start point can be easily determined by the lower right corner of the display frame being determined as the drawing start point.

The present invention is not limited to the above-described embodiment, and various modifications can be made. For example, in the embodiment, a configuration is shown in which each character string is displayed in association with a location symbol. However the present invention can be effectively applied in a similar manner when a character string is displayed in association with a designated point on an image, such as when a character string is displayed in association with a train station landmark on a map.

In addition, in the embodiment, uninverted character string data and inverted character string data are held within the map display device 1. However, these uninverted character string data and inverted character string data can be externally provided, and then outputted and displayed.

Moreover, in the embodiment, the CPU 10 identifies whether data is uninverted character string data or inverted character string data based on which layer in the map data base 20 it has been registered. However, an identifier enabling the identification of uninverted character string data and inverted character string data may be added to character string data itself, and the CPU 10 may perform, after identifying whether the character string data is uninverted character string data or inverted character string data based on the identifier, drawing processing corresponding thereto.

Furthermore, other details of the configurations and methods described according to the embodiment, such as the type of image or character string that are outputted to be displayed and each data configuration of the map database, can be modified accordingly without departing from the spirit of the invention.

While the present invention has been described with reference to the preferred embodiments, it is intended that the invention be not limited by any of the details of the description therein but includes all the embodiments which fall within the scope of the appended claims.

What is claimed is:

1. A character string display device that displays a character string on a display screen, comprising:
an ordinary character string drawing means for drawing a character string in a rightward direction from a drawing start point based on ordinary character string data in which the drawing start point is set on a left side of the character string; and
an inverted character string drawing means for drawing a character string in a leftward direction from a drawing start point based on inverted character sting data in which the drawing start point is set on a right side of the character string.

2. The character string display device according to claim 1, wherein the ordinary character string drawing means draws characters of the character string in sequence from a starting character to an ending character, and the inverted character string drawing means draws characters of the character string in sequence from an ending character to a starting character.

3. The character string display device according to claim 2, further comprising:
a top bottom switching means for switching to an inverted display mode in which character strings are displayed upside down;
wherein the ordinary character string drawing means in the inverted display mode draws the characters of the character string in sequence from the ending character to the starting character in the rightward direction from the drawing start point set in the ordinary character string data, with each character turned upside down; and
the inverted character string drawing means in the inverted display mode draws the characters of the character string is sequence from the starting character to the ending character in the leftward direction from the drawing start point set in the inverted character string data, with each character turned upside down.

4. The character string display device according to claim 2, further comprising
a map database having stored therein map image data indicating a map image, a plurality of location data respectively indicating a plurality of locations on the map image, the ordinary character string data in which a character string corresponding to one or more of the plurality of locations and a drawing start point are set, and the inverted character string data in which a character string corresponding to one or more of the plurality of locations and a drawing start point are set;
a first drawing means for drawing the map image based on the map image data; and
a second drawing means for drawing a plurality of indication marks in the plurality of locations on the map image based on the plurality of location data;
wherein the ordinary character string drawing means draws the set character string in the rightward direction from the set drawing start point on the map image based on the ordinary character string data; and
the inverted character string drawing means draws the set character string in the leftward direction from the set drawing start point on the map image based on the inverted character string data.

5. The character string display device according to claim 1, further comprising:
a font database having stored therein font data for characters;
wherein the ordinary character string drawing means and the inverted character string drawing means draw characters based on the font data in the font data base.

6. The character string display device according to claim 1, wherein the ordinary character string data includes a code indicating a character string and position data indicating at least a left-end position of a display frame of the character string, and the inverted character string data includes a code indicating a character string and position data indicating at least a right-end position of a display frame of the character string.

7. The character string display device according to claim 1, wherein the ordinary character string drawing means and the inverted character string drawing means draws pixel data to be stored in a display memory in which pixel data of the display screen is temporarily stored.

8. A character string display method for displaying a character string on a display screen, comprising:
an ordinary character string drawing step of drawing each character of a character string in sequence from a starting character to an ending character in a rightward direction from a drawing start point, based on ordinary character string data in which the drawing start point is set on a left side of the character string:
an inverted character string drawing step of drawing each character of a character string in sequence from an ending character to a starting character in a leftward direction from a drawing start point, based on inverted character string data in which the drawing start direction is set on a right side of the character string; and
a display outputting step of outputting to the display screen an image based on drawing performed in the ordinary character string drawing step and in the inverted ordinary character string drawing step.

9. A non-transitory computer-readable recording medium having a program stored thereon which is executable by a computer that generates display data of an output image, the program comprising:
program code for actualizing an ordinary character string drawing function that draws each character of a character string in sequence from a starting character to an ending character in a rightward direction from a drawing start point, based on ordinary character string data in which the drawing start point is set on a left side of the character string; and
program code for actualizing an inverted character string drawing function that draws each character of a character string in sequence from an ending character to a starting character in a leftward direction from a drawing start point, based on inverted character string data in which the drawing start point is set on a right side of the character string.
